(19) United States
(12) Patent Application Publication
(10) Pub. No.: US 2014/0019281 A1
(43) Pub. Date: Jan. 16, 2014

(54) SYSTEMS AND METHODS OF CREATING AND USING SHOPPING PORTALS

(71) Applicant: STYLSAVVY INC., San Francisco, CA (US)

(72) Inventor: Rebecca O'Dell, San Francisco, CA (US)

(73) Assignee: STYLSAVVY INC., San Francisco, CA (US)

(21) Appl. No.: 13/830,863

(22) Filed: Mar. 14, 2013

Related U.S. Application Data
(60) Provisional application No. 61/671,719, filed on Jul. 14, 2012.

(51) Int. Cl. G06Q 30/06

(52) U.S. Cl. CPC G06Q 30/0643; G06Q 30/0625
USPC 705/26.1

(57) ABSTRACT

Systems and methods of a shopping portal are disclosed. A shopping portal application may reside and execute on an electronic device (e.g., smart phone, tablet, etc.). In one embodiment, the shopping portal may partition the display of the electronic device into separately searchable areas (e.g. rows, columns, etc.) Within each area, the shopping portal may display product items that may relate to a composite product. In another embodiment, the shopping portal may access data regarding the related product items; partition said display into a plurality of separately searchable areas; display first related product items into a first separately searchable area; display second related product items into a second separately searchable area; and search first and second related product items and bring them into proximal view for the user to take additional action (e.g. buying products).

### CROSS REFERENCE TO RELATED APPLICATIONS

This application claims benefit of priority to U.S. Provisional Application Ser. No. 61/671,719 filed 14 Jul. 2012—which is hereby incorporated herein by reference.

### BACKGROUND

Today, online clothing shopping through websites, tablets and smart phone apps tends to be a very sequential and tedious process. Just in the area of shopping for clothes alone, every store website displays their clothing grouped in apparel categories of tops, pants, skirts, shoes, etc. This type of presentation tends to make it hard to visualize how clothing combine together to form outfits. For merely one example, if the user wants to put together an outfit for work consisting of a blouse, a sweater, and a skirt, they typically go to a store's website and filter the content to the apparel category of tops, then to the apparel subcategory of blouses, and then view page after page of all of the blouses that the store carries. They tend to repeat this process for the sweater and the skirt. One way to visualize how the items will combine as an outfit may be to add them to the store's Shopping Cart or to their Wish List and look at small thumbnail images.

This issue is compounded when the user wants to shop at other store websites because the user usually repeats the entire process described above for each store. Visualizing the items that make up an outfit from various retailers may be difficult without an aggregated shopping cart or wish list. Even though some websites exist that do support multiple stores and views of their merchandise, a similar issue exists as the clothing tends to be grouped in apparel categories and visualization of complete outfits may still be challenging. Additional and similar issues arise upon the user's desire to have a seamless checkout process across multiple stores and merchandise categories.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

Systems, methods and/or techniques of a shopping portal are disclosed. A shopping portal application may reside and execute on an electronic device (e.g., smart phone, tablet, etc.). In one embodiment, the shopping portal may partition the display of the electronic device into separately searchable areas (e.g. rows, columns, etc.) Within each area, the shopping portal may display product items that may relate to a composite product. In another embodiment, the shopping portal may access data regarding the related product items; partition said display into a plurality of separately searchable areas; display first related product items into a first separately searchable area; display second related product items into a second separately searchable area; and search first and second related product items and bring them into proximal view for the user to take additional action (e.g. buying products).

In one embodiment system and/or methods are disclosed for providing discovery and guidance for online clothing shopping, and closet organization through an application of an electronic device connected to a server and database. For example, the server and database that the electronic device is connected to can connect with one or more stores, affiliates, or designers to receive data reflecting their online merchandise.

In some embodiments, the application can provide functions to filter and refine the online merchandise received from multiple stores, affiliates, or designers to create different applications customized for different consumer demographics including but not limited to women's apparel, men's apparel, children's apparel, interior design, makeup, pets, etc.

In some embodiments, the application can provide functions to attract a user to view the latest styles from stores, designers, and bloggers. For example, through the application, a user can be provided with a lookbook of rich media content that promotes store brands, designer brands, bloggers, and additionally serves advertisements. In some embodiments, the application can allow the user to select a promotion or advertisement to display mini-lookbooks of multi-page content or video brand campaigns, blogger content or advertisements. For example, when the user selects a store's campaign mini-lookbook, it can expand to fill the screen of the electronic device and display a multi-page booklet of fashion content. In some embodiments, the application can allow the user to store content from the lookbooks. For example, a user can tap on a product image in the lookbook and the user will be informed that the product information has automatically been added to the user's favorites.

Other features and aspects of the present system are presented below in the Detailed Description when read in connection with the drawings presented within this application.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 illustrates an exemplary embodiment where a shopping portal application may reside for users, merchandisers, retailers or manufacturers in accordance with some embodiments of the present application.

FIG. 2 illustrates some exemplary electronic device in which a shopping portal may reside in accordance with some embodiments of the present application.

FIG. 3 illustrates one possible flowchart and/or menu presented to a user of a shopping portal application.

FIG. 4 illustrates one embodiment of a partitioned display showing different searchable areas comprising related product items.

FIG. 5 illustrates another embodiment of a partitioned display showing different searchable areas comprising related product items.

FIG. 6 depicts one embodiment of Shop view and possible functions, options or actions available to a user.

FIG. 7 illustrates one embodiment of a Macro Search within a clothing application example.

FIG. 8 illustrates an embodiment of a Macro Search as made be refined by an apparel category.

FIG. 9 illustrates one embodiment of a Micro Search within a clothing application example.

FIG. 10 illustrates one embodiment of a Micro Search as may be refined by high heels category.

FIG. 11 illustrates one embodiment of a resulting Macro and Micro Search.

FIG. 12 illustrates one embodiment of showing the detailed view of a product in a clothing application example.

FIG. 13 illustrates one embodiment of a shopping cart in the clothing application example.

FIG. 14 illustrates one embodiment of a Shopping Cart application flowchart.

FIG. 15 illustrates one embodiment of the shopping portal's shopping cart redirecting a user to the store's shopping cart.

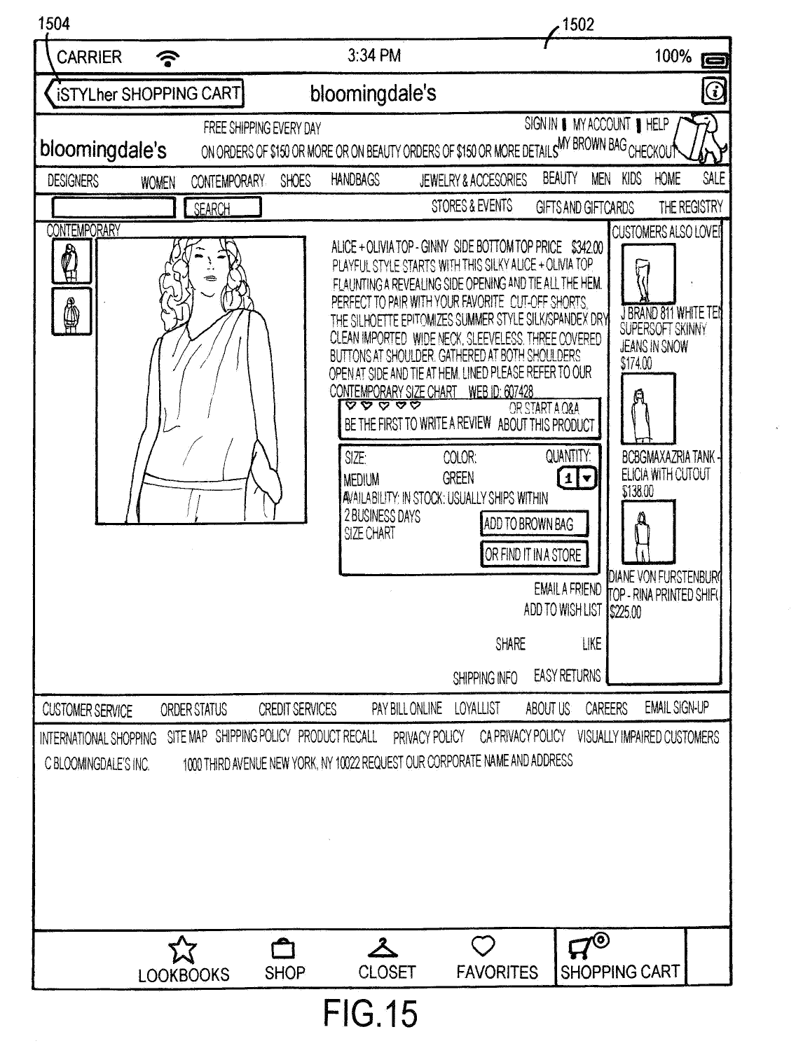

FIG. 16 illustrates one embodiment of a closet in the context of a clothing application example.

FIG. 17 illustrates one embodiment of a Closet application flowchart.

FIG. 18 illustrates one embodiment of adding a product item to the closet within the context of a clothing application example.

FIG. 19 illustrates the results of adding the product item to the closet example in FIG. 18.

FIG. 20 illustrates one embodiment of viewing the closet by items the user needs to purchase to create outfits from separates.

FIG. 21 illustrates one embodiment for viewing the closet by season filter within the context of a clothing application example.

FIG. 22 illustrates one embodiment of Favorites application flowchart.

FIG. 23 illustrates one embodiment for viewing Favorites.

FIG. 24 illustrates one embodiment of a lookbook within the context of a clothing application example.

### DETAILED DESCRIPTION

As utilized herein, terms “component,” “system,” “interface,” and the like are intended to refer to a computer-related entity, either hardware, software (e.g., in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

Introduction

Systems, methods and/or techniques for creating shopping portals for shoppers, merchandisers, stores, outlets and/or manufactures of goods are herein disclosed. While the discussion herein mainly is directed to examples in the clothing merchandise area, it should be appreciated that the systems, methods and/or techniques may be applied to any number of merchandise domains. For merely some examples, the systems, methods and/or techniques of the present application may affect shopping portals for cars, home remodeling and the like. In particular, the present application may find application in any area of shopping that allows for a plurality of options for a finished good and/or service—as well as an area where there may be a plurality of suppliers and/or manufactures that may have some possible selection going into the finished good and/or service.

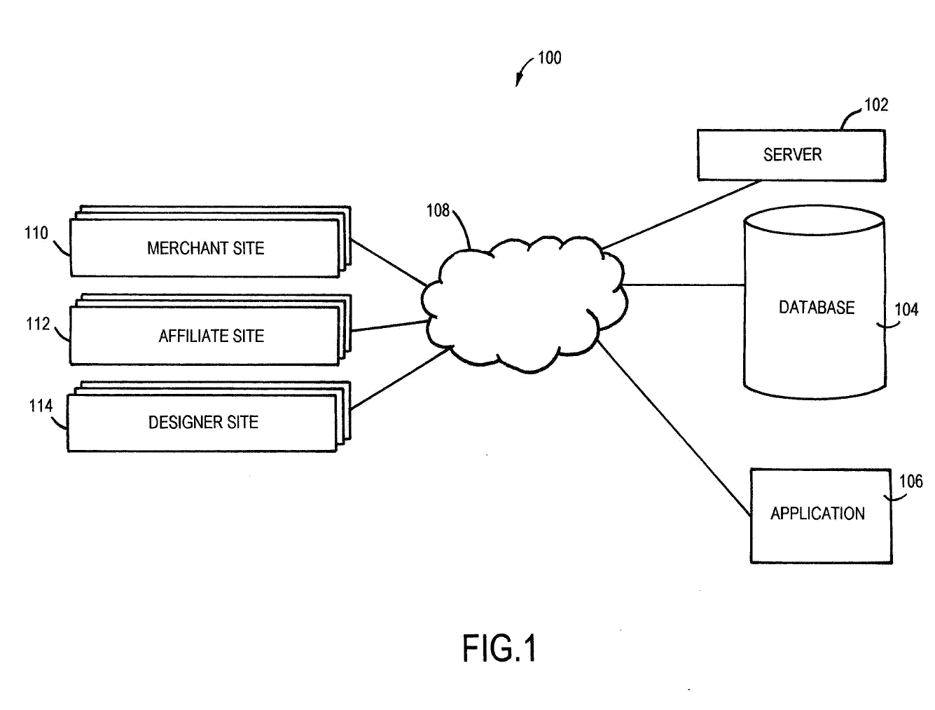

FIG. 1 is an exemplary environment in which the systems, methods and/or techniques of the present application may reside. Environment 100 may comprise a server 102, database 104 and an application 106 which may further comprise suitable components of software and/or hardware that may store, disseminate and/or execute software code that affects several embodiments of the present application.

Many models of hosting, executing or disseminating shopping portals may be affected in environment 100. In one embodiment, shopping portal application 106 may be a downloadable app from a networking environment, such as the Internet, to individual users on their computing devices (e.g., desktops, laptops, tablets, smart phones, smart devices, mobile devices and the like). Alternatively, shopping portal application 106 may be a hosted app that is accessible to users from the Internet, including a cloud-based application. In another embodiment, shopping portal application may be available at a store and available from a terminal within the store.

Alternatively, shopping portal application 106 may be hosted by retailers and manufactures of goods and services. Users may access such enterprise-hosted apps via the Internet or other networked environment (including a local area network affected on the premises of the retailer and/or manufacturer).

As may be seen, shopping portal app (and any potentially optional associated servers and/or databases) may be communications (either directly or indirectly via the Internet or any other communications network known) with a number of merchant sites 110, affiliate sites 112 and/or designer sites 114. With access to such sites, shopping portal app and optional associated servers and/or databases may download and/or populate the shopping portal application with data regarding the merchandise domain (e.g., clothing and accessories, cars and accessories, home remodeling and accessories) for users to peruse and/or select.

In the embodiment where the shopping portal application is an application placed on a user's mobile device, the shopping portal application may connect to these various sites in any manner known (e.g., Internet, other networked environments and the like).

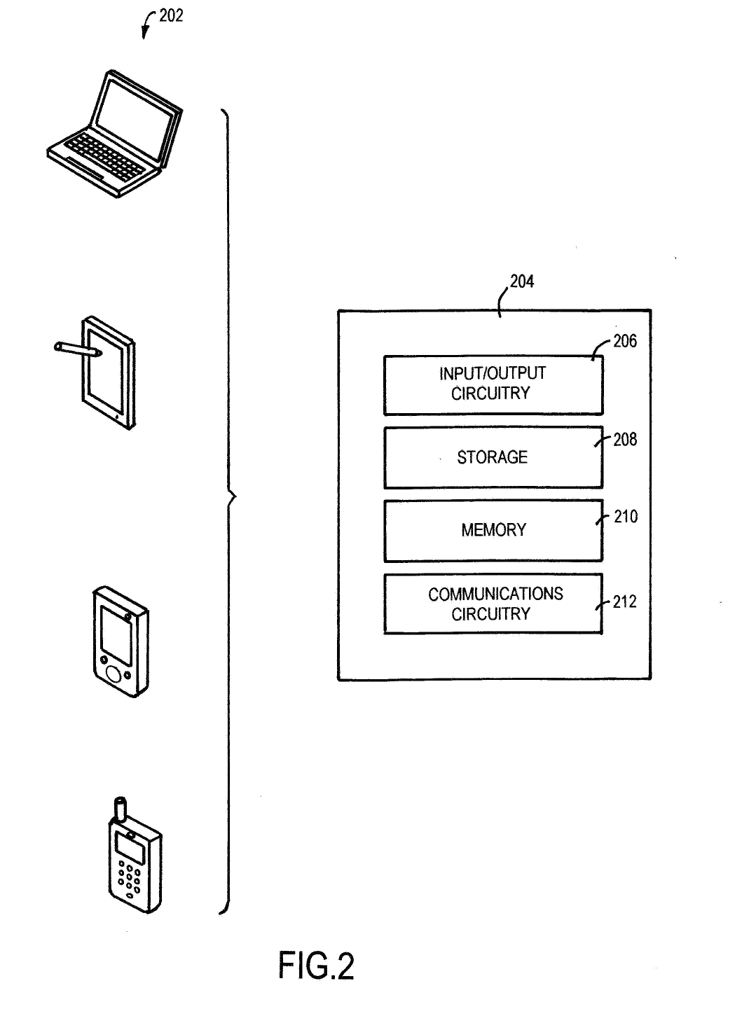

FIG. 2 depicts some embodiments of suitable electronic devices in which shopping portal application may reside. Electronic devices 202 that may be suitable include (but are not limited to): desktops, laptops, tablets, PDAs, smart devices and smart phones. It will be appreciated that this is not an exhaustive list, but a representative one, of all of the devices that may be suitable hosts and/or platforms for the shopping portal to reside and/or execute. These devices may comprise some of the following components 204: I/O circuitry 206, storage 208, accessible memory (local or remote) 210, communications circuitry 212 (e.g., any type of wireless or wired communications known). In addition, such devices would have, or have access to, suitable computer processing components to affect the operation of the shopping portal app.

In one embodiment, the shopping portal application and/or service may have access data and/or metadata to a variety of products and/or sets of products. These products or sets of products may be related in the sense that a selection of one or more products may comprise a composite product. For merely one example, in a clothing application, an “outfit” may be a composite product that may comprise a top, a bottom, shoes and an accessory. The shopping portal application may have access to data regarding a set of tops, a set of bottoms, a set of shoes and so on. Likewise, in home decoration application, a “living room” may be a composite product and “couch, tables, chairs, etc.” may be related products. The user may select—while using and searching with the software portal application—none, one or more product items that may be related to a composite product. The software portal application may access or store data and/or metadata about related product items that might comprise a composite product. In fact, the terms “related product item” and “composite product” may refer to the data and/or metadata (e.g., possibly including images, photos, CGI images, text, video, audio data and/or any associated electronic data) about actual, physical products and items.

In one embodiment, the shopping portal service and/or application may be presented to a user on any suitable electronic device (e.g., anywhere from a dumb terminal to a smart device, laptop, tablet, etc.) that may comprise a display (e.g., to show the user products) and/or a user interface (e.g., to search, select or issue other commands to the service). The display of the electronic device may be partitioned into areas that may be separately searchable. Into such separately searchable areas of the screen, the software portal application may display one such related product items or a set of related product items. For merely one example (and as shown herein), the screen may be partitioned into two or more rows and/or columns. In the clothing application, one row or column may comprise a set of tops (e.g., images, pictures or other data/metadata) from one or more merchants (e.g., vendor, manufacturer, retailer or the like). Other rows and/or columns (or otherwise separately searchable areas of the screen) may comprise other related product items (e.g., bottoms, shoes, etc.).

The term “merchant” may herein mean a vendor, retailer, seller, manufacturer or any individual or entity that had products, or access to products, that may be in commerce and may be sold to consumers. In one embodiment, the software portal application may feature products only from one merchant. In another embodiment, the software portal application may feature products from multiple merchants. For example (as shown herein), “shoes” may be displayed to the user from any number of shoe merchants.

The user may independently search (e.g., via scrolling on a touch-sensitive screen, text searching or the like) these areas and bring the data and/or metadata of these related products into proximity with each other. As mentioned, the user may either select none, one or many such related products to subsequently purchase.

In one embodiment, it may be desirable that the shopping portal application, at startup, have multiple category rows in the Shop view configured by the server and are unique for each product. When the application starts up, it may send the server a configure request indicating which product it is. The server sends the application a configure response containing the category rows defined for that product. For instance, in the clothing portal example, the rows are defined in terms of apparel categories. For a woman's apparel application, they may include Dresses, Tops, Bottoms, Shoes, and Accessories. But the rows for a man's apparel application may include Outerwear, Tops, Bottoms, Shoes, and Accessories. Further, if a home decoration application is being defined, the rows may be defined in terms of furniture and accessories. The interior design application may include Chairs, Sofas, Rugs, Lighting, and Accessories. For such products defined by the server, new row headers may be added or current row headers may be deleted or re-ordered by the server in real time. Many applications can be defined including but not limited to women's apparel, men's apparel, children's apparel, interior design, makeup, pets, etc.

As will be discussed herein, a Macro and Micro Search attributes may also be defined and configured by the server, and sent as part of the configure response. Attributes may be modified and additional attributes may be added in real time.

Clothes Shopping Portal Embodiments

As was mentioned previously, while the systems, methods and/or techniques of the present application finds application in any number of merchandise domains, the various embodiments discussed herein will focus on the clothing and accessories domain merely for the purposes of exposition—and is not meant to narrow the scope of the claims of the present application.

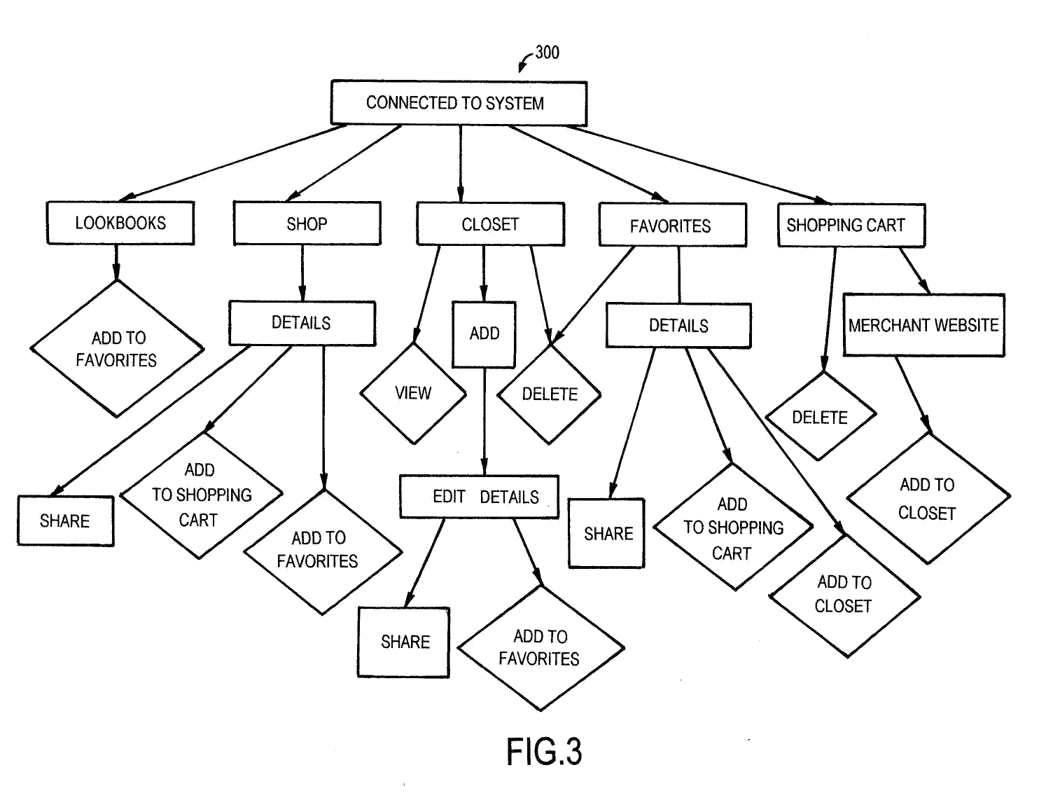

FIG. 3 is one possible flowchart and/or menu 300 that may be presented to the user of one embodiment of a shopping portal application. User may connect to the system in any number of ways known in the art. For example, users may connect remotely to a hosted shopping portal application, or may have downloaded the shopping portal application onto his/her smart device, or in any other known manner of connecting to an application.

Once connected, the user may be presented with a menu of options from which to select. For example, as seen in FIG. 3, the user may select from a list—e.g., Lookbooks, Shop, Closet, Favorites, Shopping Cart—as possible options and/or actions to take. Each of these options/actions, in turn, may have other options/actions from which to select. For example, from Lookbooks, user may select “Add to Favorites”. From Shop, users may select Details—which may further comprise options/actions such as Share, Add to Shopping Cart, Add to Favorites—among other possible options/actions. From Closet, users might select View, Add or Delete. Add option/action may further decompose into Edit Details—which, in turn, may decompose into other options/actions such as Share or Add to Favorites. From Favorites, users might select Delete or Detail (which may decompose as previously mentioned). From Shopping Cart, users may either select Delete or an item to purchase and be redirected to the Merchant's Web Site. Returning from the Merchant's Web Site, the user might be given the option/action of adding to a purchased item to Closet. It will be appreciated that the above recitations of options/actions is not exhaustive—there may be many more options/action available, or some options/actions not present as optional.

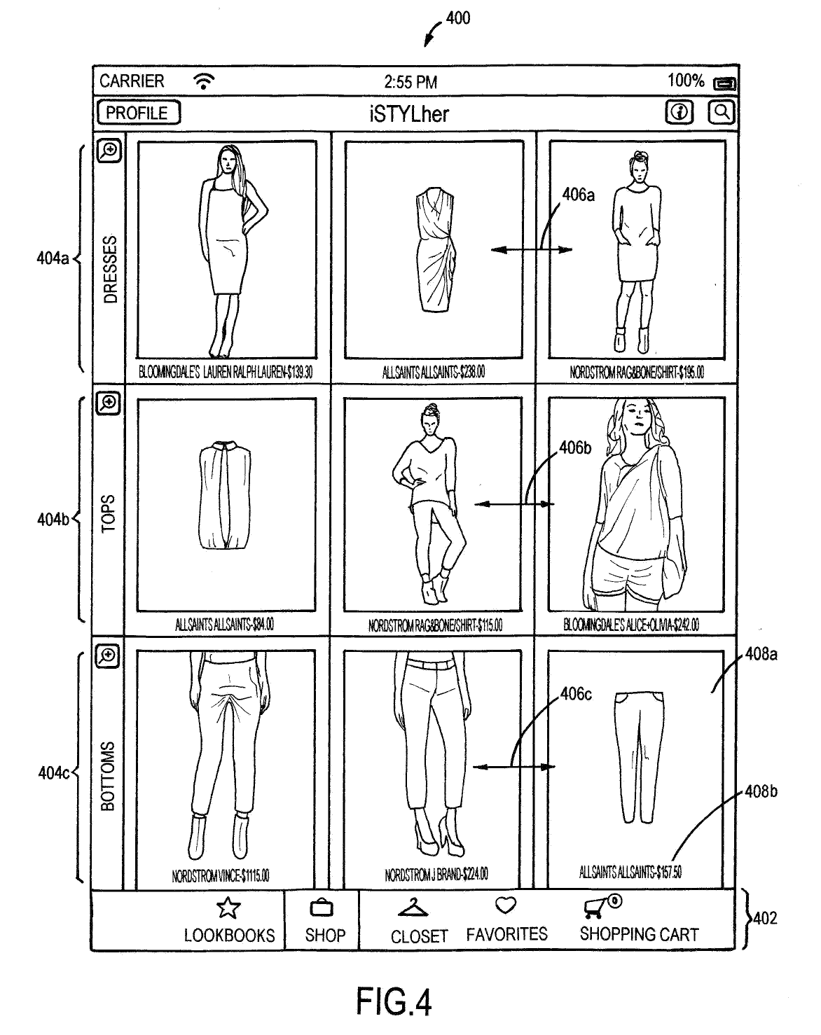

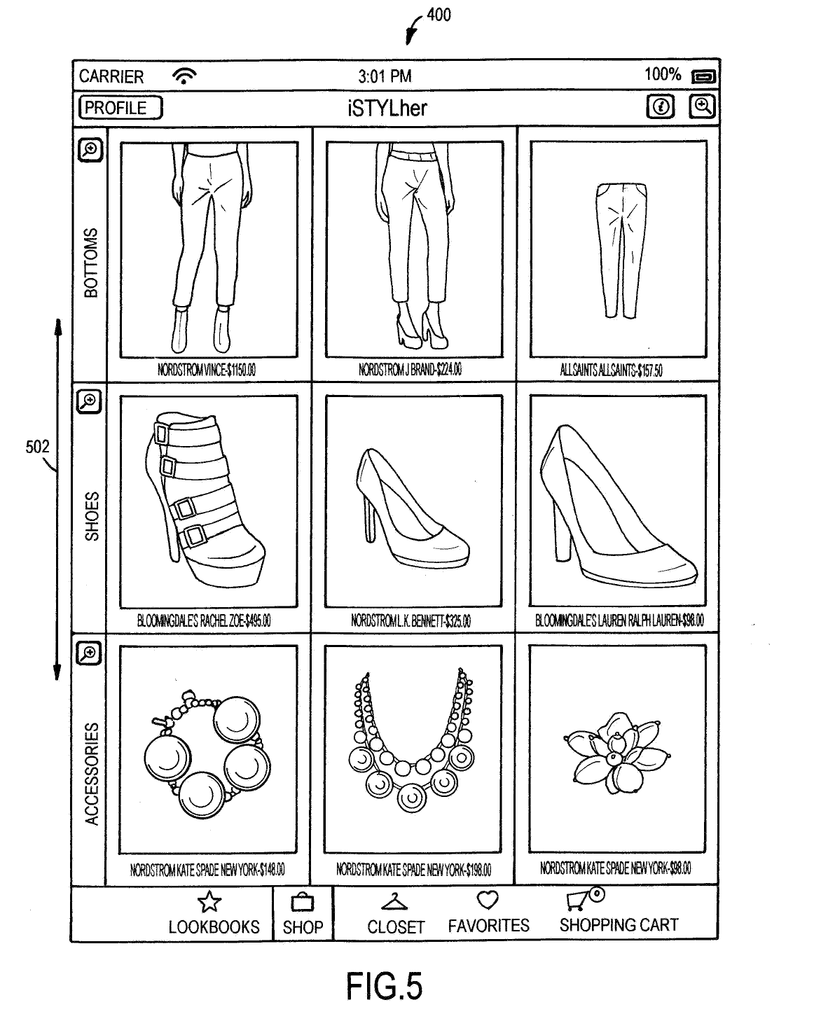

FIGS. 4 and 5 illustrate one embodiment view 400 of the Shop menu option/action. View 400 depicts one possible screen shot as might appear on any of the aforementioned electronic devices that might be running the shopping portal application, either directly or remotely (e.g., in terminal mode). View 400 may present to the user a main menu 402 of options/actions to take. In FIGS. 4 and 5, the user has selected the Shop option/action—however, it may be seen that other options/actions are potentially selectable by the user.

View 400 takes a merchandise domain that might have a plurality of options for a more completed merchandise items and/or associated items—for example, creating a view of a full or partial outfit ensemble for clothing merchandise. View 400 may have an effective partition of the screen to highlight different aspects or portions of the merchandise ensemble. In continued reference to FIG. 4, view 400 comprises three different aspects visible to the user—i.e., Dresses 404a, Tops 404b and Bottoms 404c.

In one embodiment, a user interface (UI) may be presented to the user such that the separate portions and/or aspects forming the partition may be independently searchable and/or scrollable. For example, Dresses 404a may be scrolled horizontally 406a independently of Tops 404b (horizontally scrollable as shown as 406b) or Bottoms 404c (horizontally scrollable as shown as 406c)—and each potentially independently scrollable from the other. Such a scrolling interface for a partitionable user interface is possible in a variety of implementations. For example, if this view is presented on a touch-sensitive screen, then the user may scroll any one portion by moving a finger across the screen in either direction to get the portion to scroll horizontally. In addition, if the view is presented on a non-touch-sensitive screen, the portion may still be scrollable through keystroke or mouse action. A separate scroll button may be placed on the view depending on the platform the shopping portal application is residing. Thus, Shop view may allow the user to visually discover and create outfits by scrolling the apparel category rows horizontally and then vertically lining up the product images as outfits.

As may be seen in FIG. 4, view 400 presents the user a 3×3 array of individual merchandise items—e.g., a photographic (or other representational view) information 408a (e.g., of a pair of pants here) and additional data/metadata 408b of that merchandise item (e.g., of the manufacturer/retailer, brand and its price). It will be appreciated that other views may present an n×n array of individual items and each item may have other information associated with the item for display for the user (or within easy access of the user by a sequence of keystrokes, mouse movement, touch gestures or the like).

In FIG. 5, view 400 may be scrolled vertically 502 to present a view of different clothing parts—e.g. the view may have been scrolled upwards twice to reveal a view of Bottom, Shoes and Accessories (i.e., and no longer showing Dresses or Tops—in a three horizontally partitioned view).

As may be seen in FIGS. 4 and 5, the user may be able to scroll the entire content vertically pass the Dresses and see how Tops and Bottoms may coordinate with each other—thus, creating an easy and intuitive interface for shopping across different portions of an outfit and/or ensemble.

As will be discussed further herein, multiple product items of the n×n array may be selected by the user to create a composite image and/or field of data/metadata that may be viewable by the user as a composite and/or an ensemble. For example, for an apparel application, the user may create outfits by selecting a top, a bottom, a pair of shoes and, perhaps, an accessory (e.g. handbag)—and the application may display and/or save the combination/composite/ensemble in a single view—e.g., in a section of the Closet. The composite image may be a 2D or a 3D image, and may be possible to magnify on portions of the composite to see and/or visualize what the composite would look like. In one embodiment, the software portal application may comprise sufficient image processing such that the image of a first related product item may be merged and/or otherwise manipulated with the image of a second related product item such that the application may display for the use a composite and/or resulting image that would substantially resembles said a subset of said composite product.

For another example in an interior design application, it may be possible for a user to select a couch, a love seat, tables, chairs and the like from different manufactures/retailers—on a one by one basis—and then view the combination in an exemplary room view. Alternatively, if a picture or image of the user's room is available, the composite selection of furnishings may be superimposed on that particular image to give the user an idea/visualization of how the room would look with those particular items.

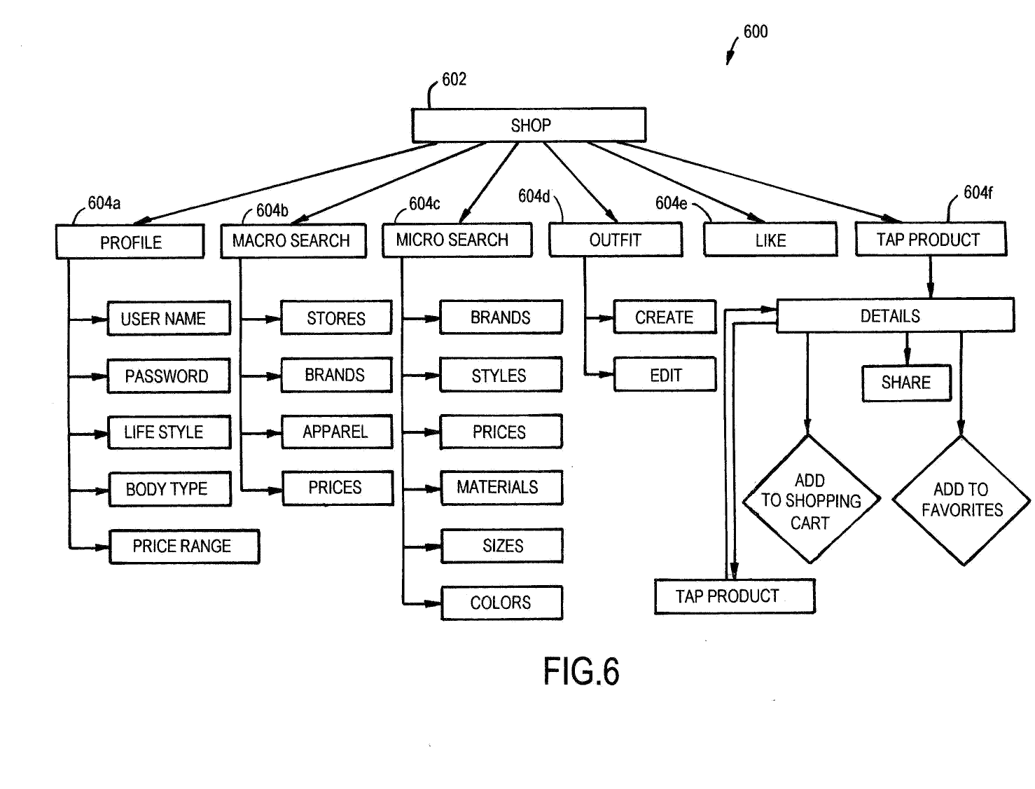

FIG. 6 is one possible embodiment of a Shop menu 600. Users may enter Shop option/action 602 in any known manner of launching an action within an application. Shop option/action may allow for a number of sub-options/actions, such as: Profile 604a, Macro Search 604b, Micro Search 604c, Outfit 604d, Like 604e and/or Tap Product 604f. Profile option 604a may further comprise options/actions and/or data/metadata fields (as all options/actions may further comprise some data and/or metadata associated with the option/action). In this embodiment, Profile 604a may capture information and actions particular to a given user or class of users. For example in the field of clothes shopping, Profile may comprise: User Name, Password, Life Style, Body Type and Price Range—all giving some data/metadata about a user or set of users. This information may be sent to—e.g., the server, that may in turn adapt the product content customized to the user's profile.

Multiple Searching Embodiments

In many embodiments, there may be a plurality of searching options/actions that allow a refinement of results presented to the user—e.g., to hone in quicker on desired composites/ensembles. In continued reference to FIG. 6, Macro Search 604b may comprise: Stores, Brands, Apparel, Prices—which may be fields of data in which the user may specify and search. Micro Search 604c may comprise: Brands, Styles, Prices, Materials, Sizes and Colors. As will be discussed further herein, Macro Search and Micro Search are merely terms for two different searches across a database or set of databases. In one embodiment, Macro Search may apply to the entire product content of the Shop view and Micro Search may apply to the product content of an individual row.

It should be appreciated that there may be other embodiments of a multiple searching feature that may be applied to a shopping portal application. For example, there may be two search features (e.g., a Search 1 and Search 2) that may be at the same level in a database—or, alternatively, the Search 2 may be a refinement search on the results retrieved after the Search 1. For the purposes of the present application, it may desirable to have two or more searches—carried out at the same level, or different levels—within a database or a set of databases.

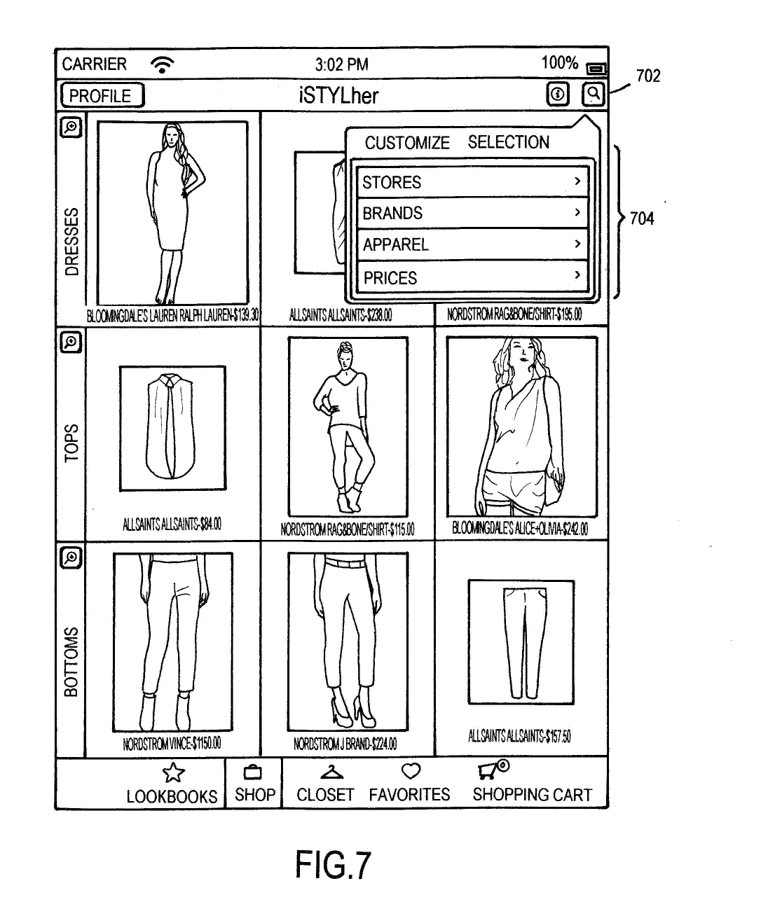

One example of the Macro Search is shown in FIG. 7 and illustrates one implementation this system may provide for filtering all of the product content on the shopping view. FIG. 7 illustrates the Macro Search filters that can include (but are not limited to): Stores, Brands, Apparel, and Price Range. Any combination of these filters can be selected to narrow down and refine the entire (or a portion thereof) product content on the Shop view.

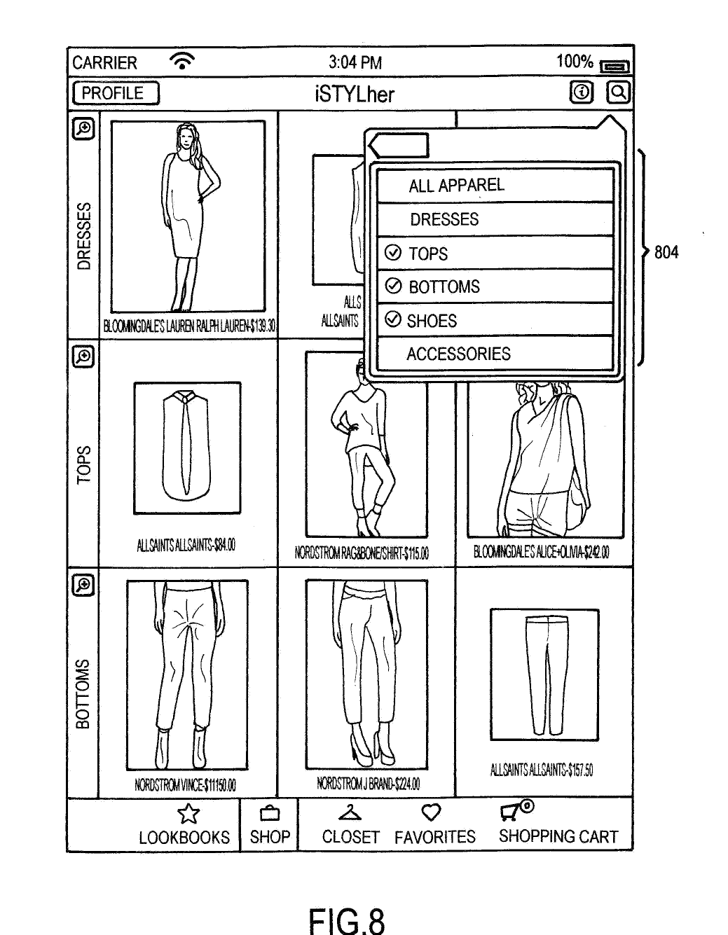

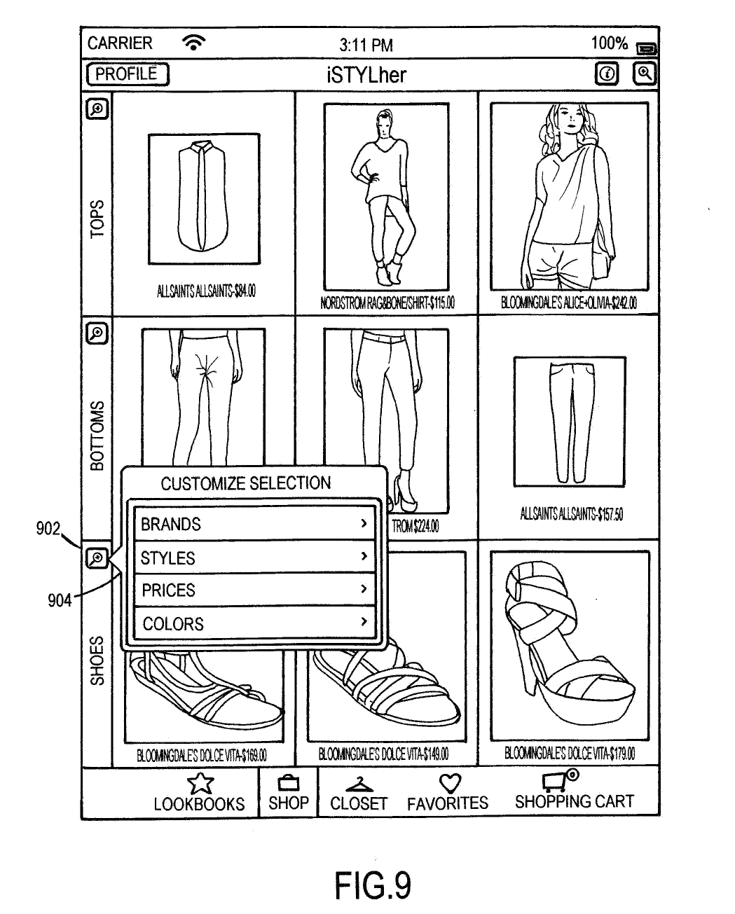

FIG. 7 through FIG. 9 illustrates how one embodiment of the Macro Search may be used to filter which apparel category rows are displayed on the Shop view. In this example, the user may tap the Macro Search button 702 on the upper left-hand corner of the Shop view to display a Macro Search popover 704. The user then taps on the row labeled Apparel and the popover view changes to show the Apparel attributes 804, as illustrated in FIG. 8. The user may tap on any combination of one or more attributes in order to customize the rows that are displayed. The example in FIG. 8 shows Tops, Bottoms, and Shoes being selected. Finally, FIG. 9 illustrates the result of the search where only the Tops, Bottoms, and Shoes apparel category rows are displayed on the Shop view.

In addition to being able to customize which apparel category rows are displayed on the Shop view, the Macro Search can also narrow and refine the product content by one or more stores, brands or price ranges.

Micro Search

In one embodiment, the Micro Search provides for filtering the product content of a single row on the Shop view. In continued reference to FIG. 6, Micro Search 604c may comprise: brands, styles, price range, materials, colors, and sizes. By selecting any combination of these filters, the product content for a single row on the Shop view is refined by that selection.

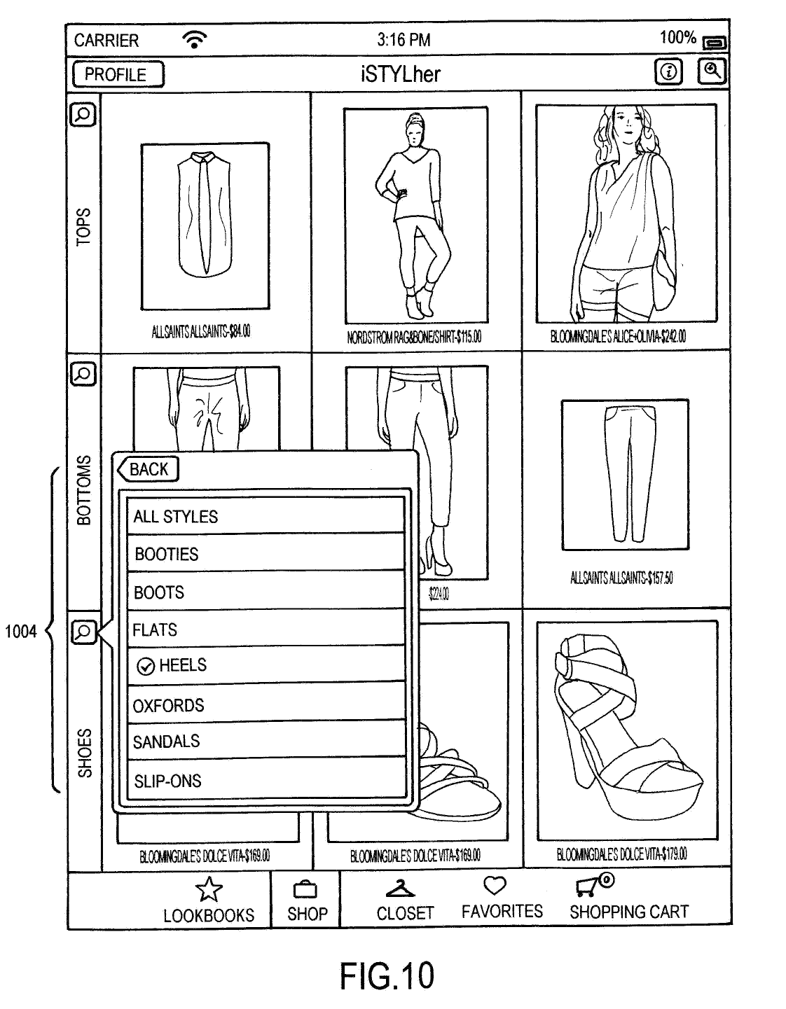

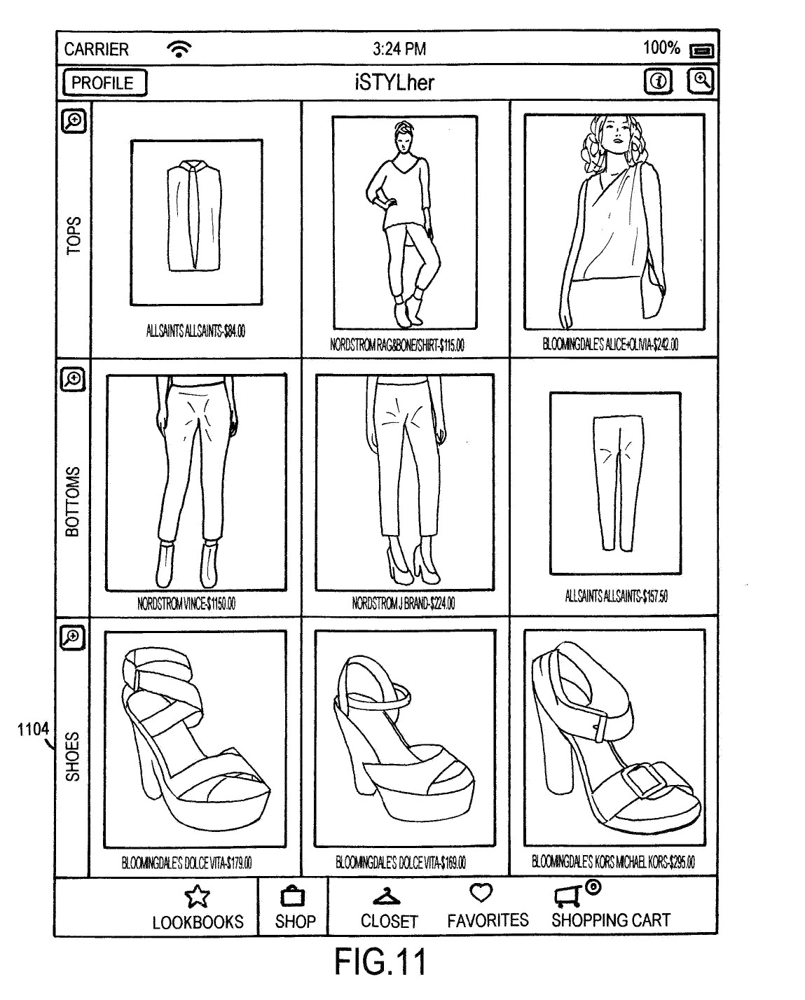

FIG. 9 through FIG. 11 illustrates how the Micro Search is used to filter the product content displayed on the Shoes row of the Shop view. The user may tap a Micro Search button (902) at the top of the row's header on the left side of the view to display the Micro Search popover (904). The user then may tap the row labeled Styles and the popover view (1004) changes to show the Styles attributes, as illustrated in FIG. 10. The user may tap on any combination of one or more of the style attributes in order to refine the product content for the Shoes row. The example in FIG. 10 shows Heels selected. Finally, FIG. 11 illustrates the result of the search—i.e., shoes with heels are displayed to the user in row 1104.

In one embodiment, the Micro Search provides the user the capability to narrow the product content for one or more category rows to define a specific outfit—such as, searching for white blouses with brown leggings and red heels.

In many embodiments, an ensemble or composite may be created from multiple products and/or multiple category rows. In continued reference to FIG. 6, to affect Outfit 604d, an Outfit button may be provided on an apparel application that, when tapped by the user, enables the application to enter an ‘outfit edit’ mode that allows the user to tap multiple products from multiple apparel category rows to create an outfit. When the user has included all of the pieces for the outfit, they tap the Outfit button again exit the ‘outfit edit’ mode. A new Outfit view may be displayed that includes the product images selected by the user. In other embodiments, the user may move the product images, resize them, and rotate them to create an outfit collage. In other embodiments, the user may extract or ‘cut out’ the product from the product image and arrange it or superimpose it onto an image view of their own body. In this scenario, the user may move, resize, and rotate the extracted product to fit the body image. Once completed, the user can save the outfit to a special section of the Closet.

It will be appreciated that other methods and/or techniques may be employed to affect an Outfit view. In particular, such commands for selecting products and commanding an outfit view may suffice for the purposes of the present application. For example, other keystrokes, mouse clicks and touch-based gestures may be affected for users to select multiple products and command that a subsequent “composite view”. Additionally, this feature is applicable to other applications of the shopping portal application. For example, in the interior decorating example, a user may select a number of products from a furniture category (e.g. a couch, chairs, a table). Once selected, the user may command a Composite View of the selected products within a room. The room may be a CGI created room image—or may be an actual photo of the room owned by the user. The products may be superimposed graphically into the room and moved around the room (e.g., as bitmap images). This would give the user an idea and/or visualization as to how the selected items would match in its proper context (e.g., whether the context is a completed clothing outfit, a completed room in an apartment or the like).

In many embodiments, products may be crowd-sourced rated by popularity. In continued reference to FIG. 6, Tap Product 604e, a small Like button can be located on a corner of each product in the Shop view. As the user browse through the apparel category rows, they can quickly tap the Like button for products that appeal to them. All products that are ‘Liked’ in this fashion may be sent to the server, where the information may be accumulated in the form of a popularity rating for each product.

Detail Product View Embodiment

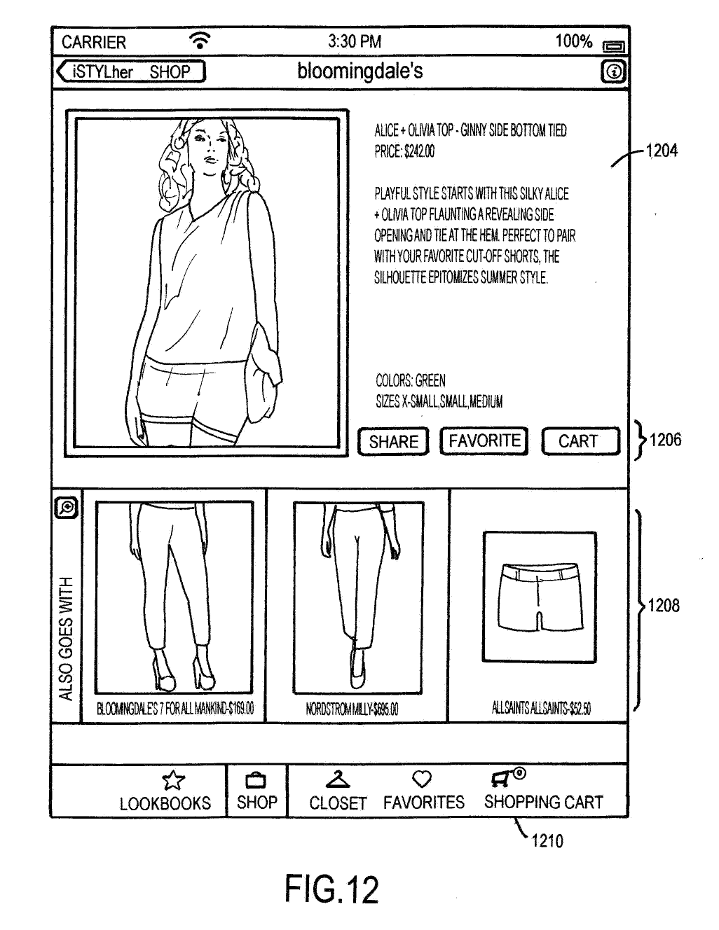

In many embodiments, a product's detail may be viewed. In continued reference to FIG. 6 and Tap Product 604f, when the user taps a product on the Shop view, the Shop Detail Product view (1204) for that product may be displayed as illustrated in FIG. 12. The Shop Detail Product view may present a larger product image, the brand, the product description, the price, the sizes, and the colors.

Shop Detail Product view may display one or more options/actions (as seen as three buttons 1206). The Share button may allow the user to share the product via email and/or socially, including but not limited to: via Facebook, via Pinterest or via Twitter. The Favorite and Shopping Cart buttons on the Shop Detail Product view allow the user to add the product to their Favorites and/or to their Shopping Cart respectively. As the user adds products to the Shopping Cart, the badge on the Shopping Cart tab at the bottom of the view increments by one.

The scrolling row of products (1208) along the bottom of the Shop Detail Product view presents additional items to go with the detailed product allowing the user to visually discover more ways to complete an outfit. The product content may be refined and narrowed using a Micro Search button. As the user taps product images on the scrolling row, new Shop Detail Product views may be recursively displayed for those products allowing the user to continue to refine outfits.

Shopping Cart

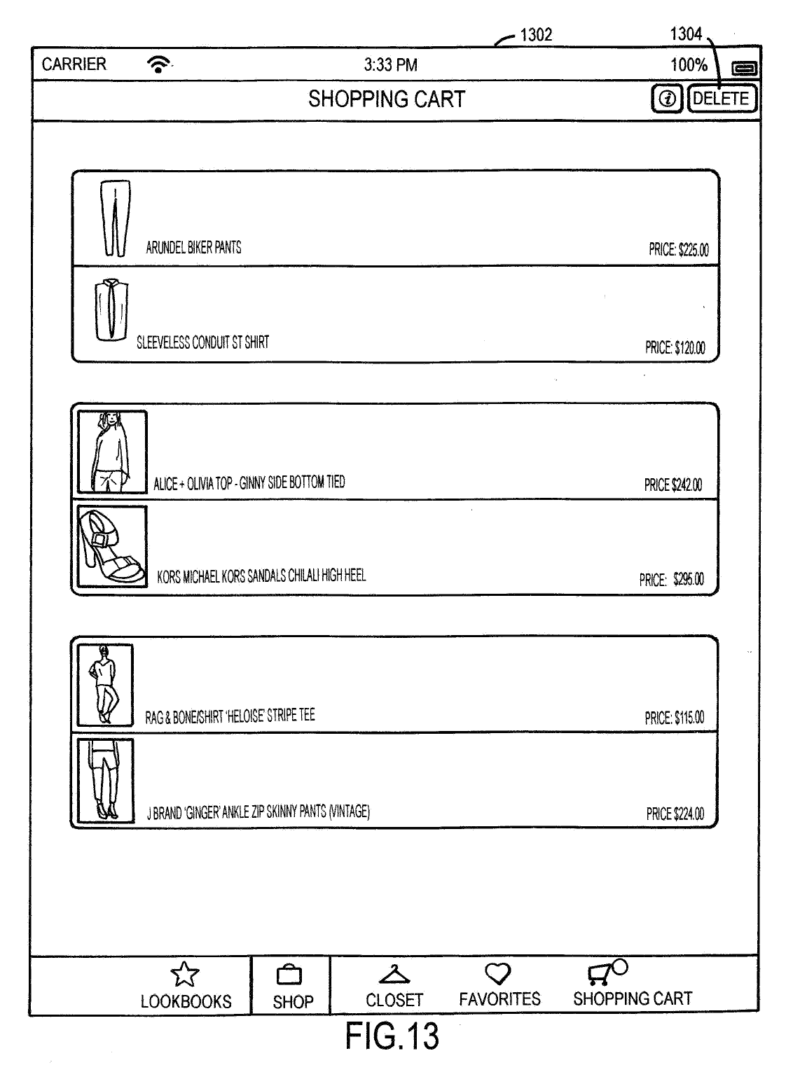

As the user shops for clothing on the Shop view (FIG. 4) and review items they like on the Shop Detail Product view (FIG. 12), users may add the item to the Shopping Cart. When the user is ready to purchase items, they may tap the Shopping Cart tab (1210) located at the bottom of the application to display the Shopping Cart view (1302) as illustrated in FIG. 13.

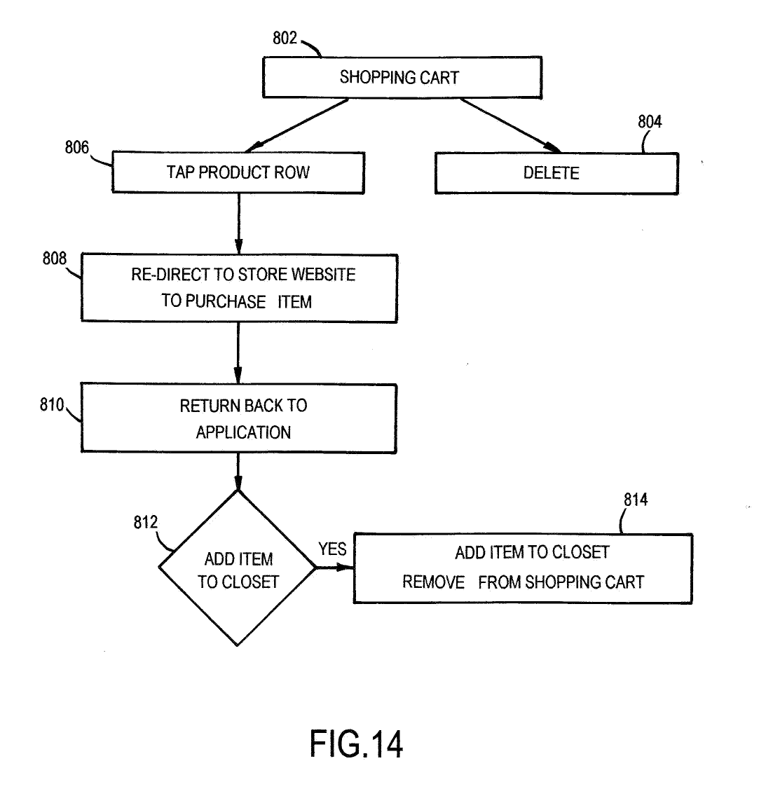

One embodiment of a Shopping Cart Flow Diagram is shown in FIG. 14. Upon entering Shopping Cart, the user may decide not to purchase an item and Delete (804) the item from the cart. Alternatively, the user may initiate the purchase by selecting or tapping on a shopping cart row item (806)—which may redirect the user to the particular store/merchant/manufacturer web site that supplies and/or sells the item (808). Once the transaction is complete, the user may return to the shopping portal application (810) by selecting the application Shopping Cart button at—e.g., the upper left corner (1504). After returning, the shopping portal application may ask the user if they would like the item to automatically be added to the Closet, as discussed further herein, at 812 and, if so, the item may be added and removed from the Shopping Cart at 814.

Affiliate Model Processing

The systems, methods and/or techniques of the present application may be used to support a number of use models and business models. For example, it may be desirable to have shopping portal application support a seamless checkout process on multi-store websites—particularly, as some store website has its own fulfillment center and others not. Websites that do not have their own fulfillment center may use an affiliate model where the store (the advertiser) approves the website (the publisher) to publish the store's merchandise on the publisher's website. The user shops for clothing from multiple stores on the publisher's website and, as they select items they want to purchase, they may be redirected to that store's website where the purchase transaction may be completed. Once on any store's website, the user selects the size and color of the item, places it in the store's shopping cart, and purchases the item. After the purchase is complete, the user may be redirected back to the publisher's website to continue shopping.

Publisher's websites are typically designed where the user may be allowed to purchase each item, one at a time, as they are viewing its product details. This design may not allow the user to collect numerous items in their shopping cart before checking out.

One typical use pattern when shopping for clothing online is where the user adds many items to their shopping cart but only intend to purchase a few items. In the area of clothes shopping, it may be the case that the user wants to purchase a dress, for example, and collects multiple dresses that they like in the shopping cart before narrowing it down to one item. Another scenario occurs where the user collects multiple items from different apparel categories; but they only have a budget to purchase one or two items. In this case, the user may collect many items in their shopping cart so they can narrow the items down when they are ready to make the purchase. During the check out, they may select one or two items and either delete the other items or mark them for a later purchase.

In one embodiment, the shopping portal application may employ the affiliate model and provide products from many stores. In this model, the Shopping Cart view may provide an organized aggregation of products from multiple stores, by partitioning all or some shopping cart product items into groups of stores as illustrated in FIG. 13. The user may decide to remove products from the shopping cart by pressing the Delete button (1304) to enter a “delete” mode, where the user selects product rows that are removed from the shopping cart upon selection.

Closet Organization

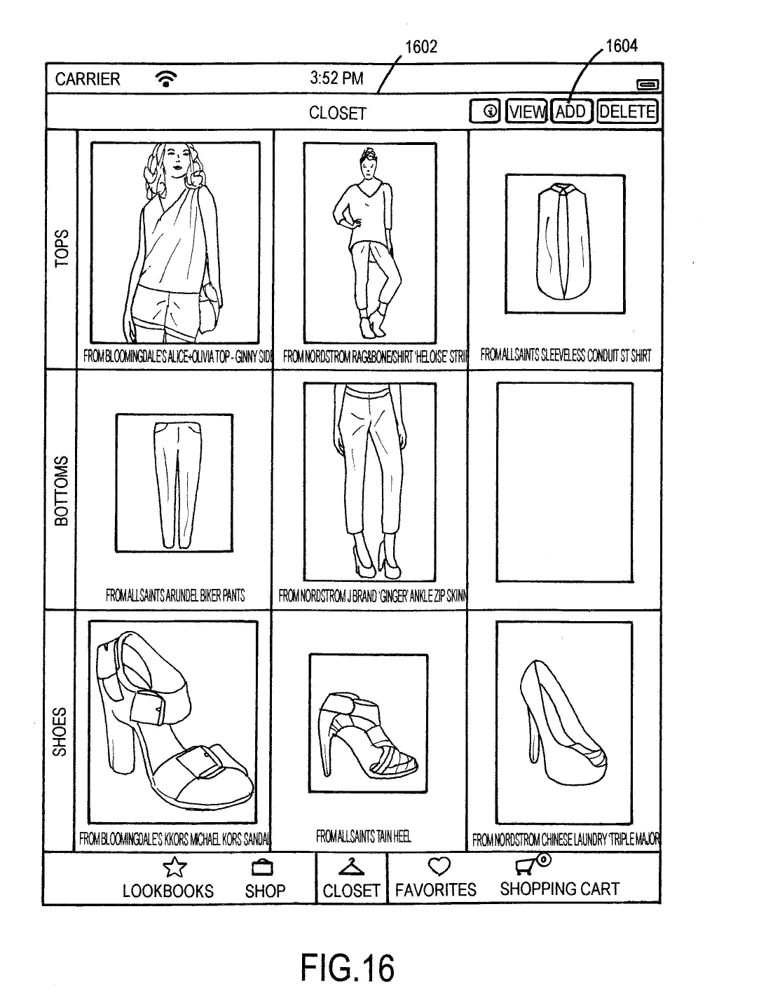

In one embodiment, the user may tap the Closet tab located at the bottom of the application to display the Closet view (1602), as depicted in FIG. 16. In this embodiment, a user's Closet may represent all or a subset of user's physical or virtual items. It will be appreciated that while the choice of the name “Closet” may be associated with clothing, the term “Closet” also may refer to an electronic storage of data and/or metadata about related product items that might comprise a composite product. In fact, the terms “related product item” and “composite product” may refer to the data and/or metadata (e.g., possibly including images, photos, CGI images, text, video, audio data and/or any associated electronic data) about actual, physical products and items.

In the clothing application, a Closet may comprise these related product items may be: dresses, tops, bottoms, shoes, accessories or the like. In the interior decorating application, a Closet may comprise these related product items: couches, chairs, tables, lamps, electronic goods and the like. A Closet may comprise enough related product items to from a composite product—e.g., and outfit, or a decorated room—or it may comprise a subset of such related products (e.g., one closet may comprise only tops and bottoms). Other naming conventions are also possible. For example, in the area of home furnishing/decoration, the option/action may be called “Room” or “Home” or the like, instead of “Closet”.

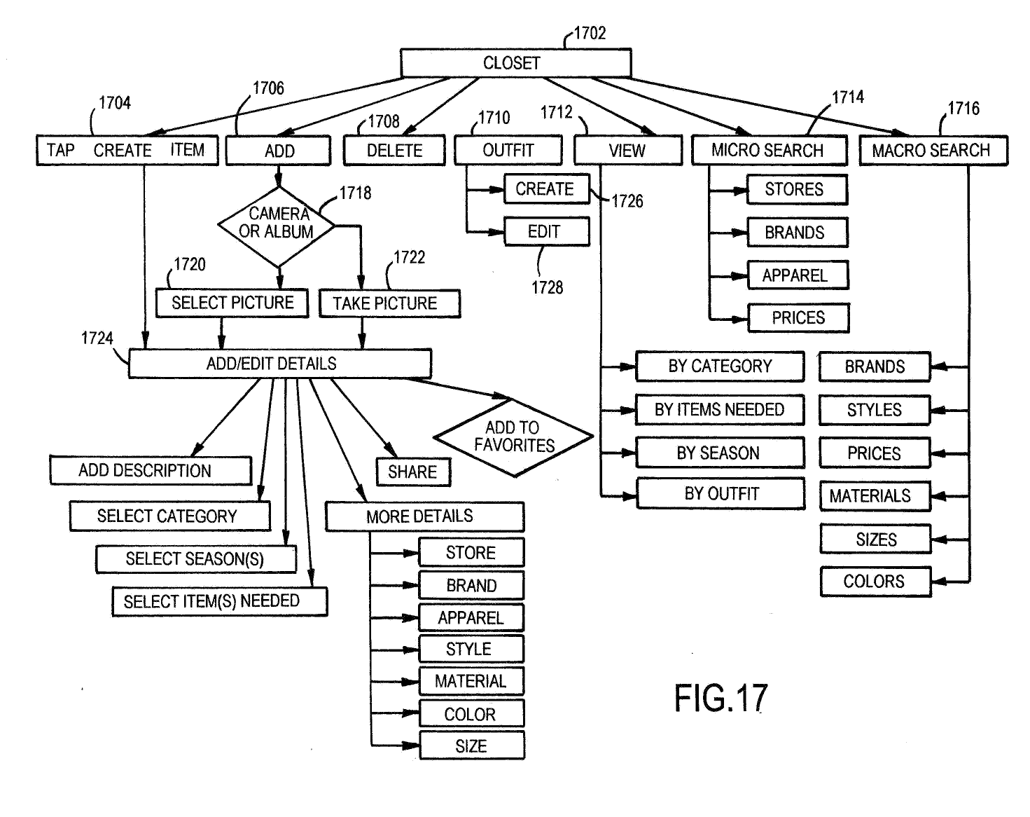

One embodiment of a Closet Flow Diagram is illustrated in FIG. 17. The user may enter the Closet in any manner known at 1702. A menu may present a number of items and/or features that may allow the user to organize the closet—such as, Tap Closet Item (1704), Add (1706), Delete (1708); Outfit (1710), View (1712); or Macro Search (1714) and Micro Search (1716). All of these menu items may be buttons (soft or otherwise) displayed on the screen or any other actuator known (e.g., software switches, hardware buttons on an electronic device or the like). As discussed further herein, the closet items on the Closet view can be refined and filtered using the Macro Search and the Micro Search. As also discussed further herein, an Outfit button may be provided to allow the user to create outfits from a combination of their closet items. A Delete button may be provided to allow the user to remove items from the closet as discussed herein.

Items can be added to the Closet either by the application automatically adding purchased items, as discussed herein—or by manually adding pictures of the user's clothes (1718, 1720, 1722). All closet items may be stored in the database for the purpose of shopping specifically for the item in the user's Closet on the shopping portal application.

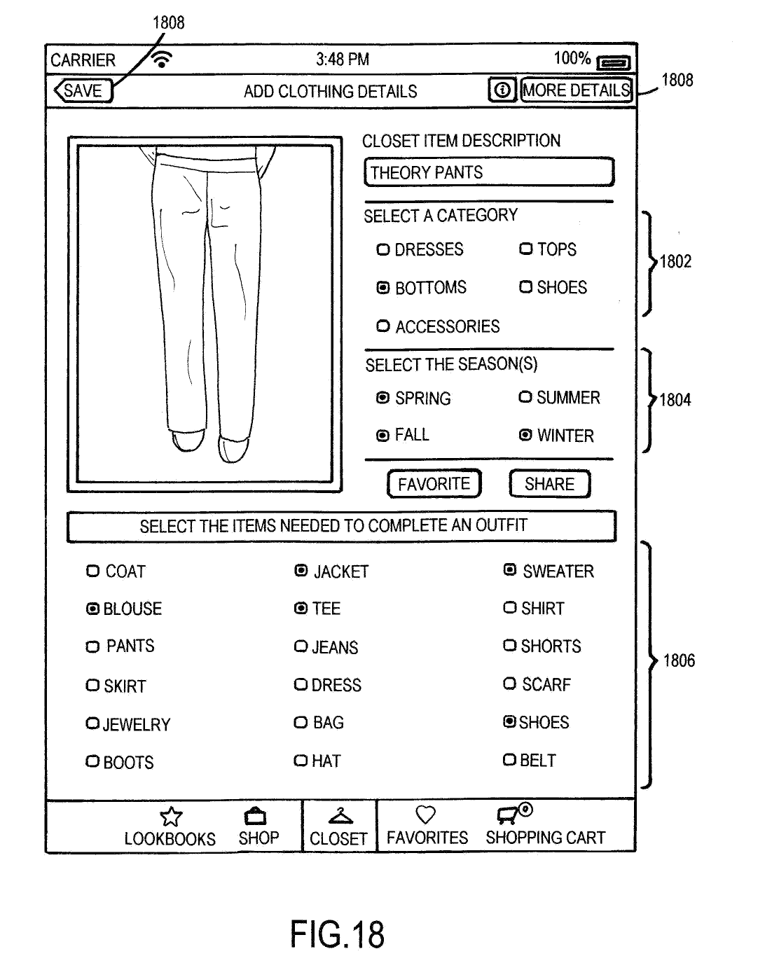

In one embodiment, the user may manually add closet items by tapping the Add button (1604) located at the upper right corner of the Closet view. A popup may appear (1718)—e.g., asking the user to select adding a closet item by taking a picture from the camera (1722) or selecting a picture from the photo album (1720). Once the user either takes a picture or selects an existing picture, the Closet Add Details view appears, as depicted in FIG. 18. This view allows the user to edit attributes that include, but are not limited, to a textual description, the apparel category (1802), the season(s) of the item (1804), and the item(s) needed to complete an outfit (1806). The user may select the More Details button (1808) to add more closet item attributes, including but not limited to: store, brand, apparel, style, material, size and color.

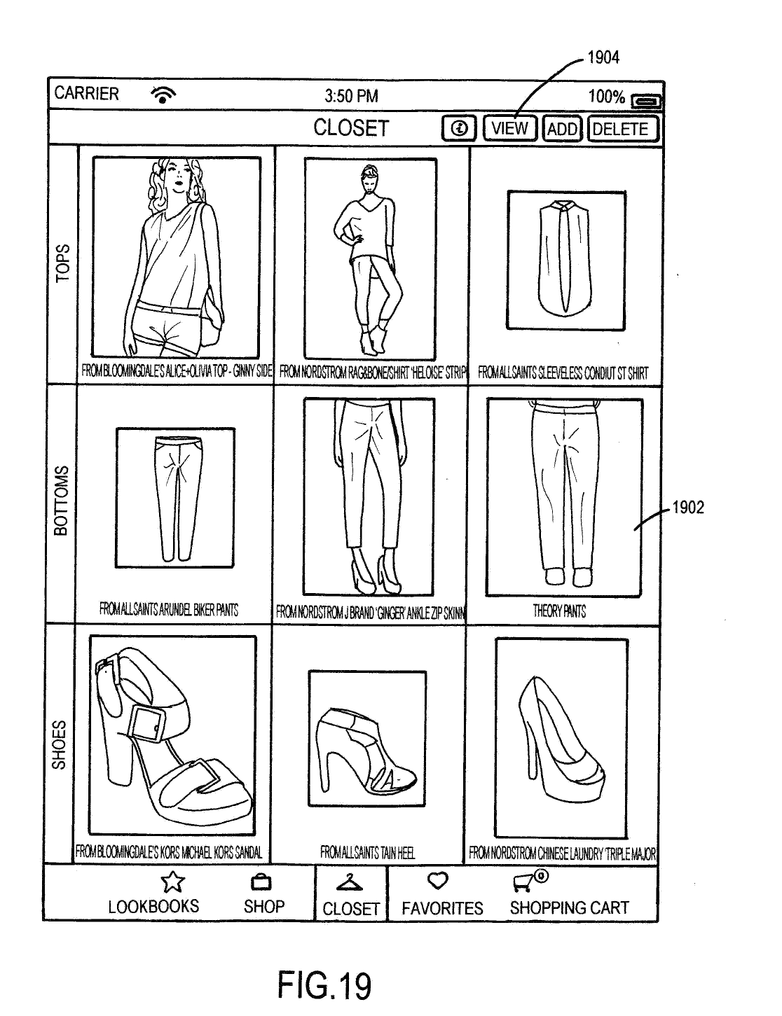

The user may then press the Save button (1808) at the upper left corner to return back to the Closet view—and the item (1902) has been added to the Closet, as depicted in FIG. 19.

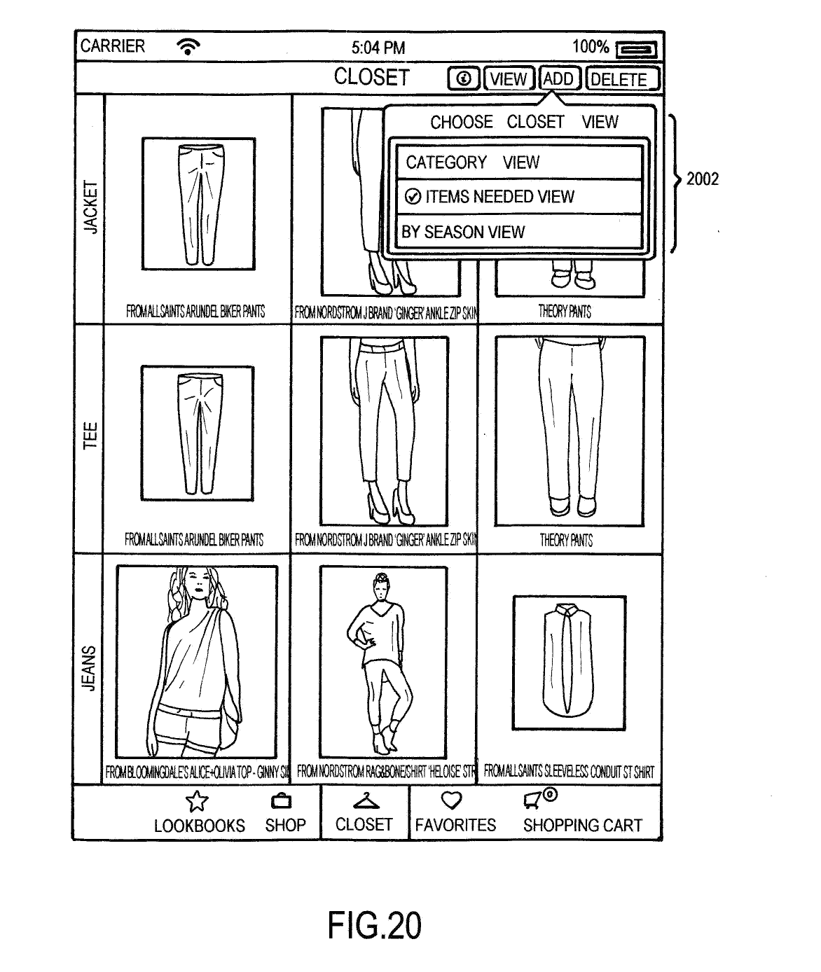

In one embodiment, the View button (1904) located at the upper right of the Closet view may provide a plurality of ways to view (2002) the clothing in the closet: e.g., by Apparel Categories, by Items Needed, and by Season, as may be seen in FIG. 20. Each view modifies the row headers and the organization of the rows displayed. A default view may be presented—e.g., by Apparel Category as illustrated in FIG. 19.

The Items Needed View is illustrated in FIG. 20. In this view, the rows are labeled with the clothing item that the user needs to purchase in order to complete an outfit. Each row may comprise the user's closet items that need the clothing item. This view may help the user to visualize what items they need to purchase in order to create outfits from the separates in their closet. To set the Items Needed tags on any closet item, the user taps the closet item in the Closet view (FIG. 19) to display its Add Details view (FIG. 18). The user then selects one or more of the Items Needed tags and saves to return to the Closet view.

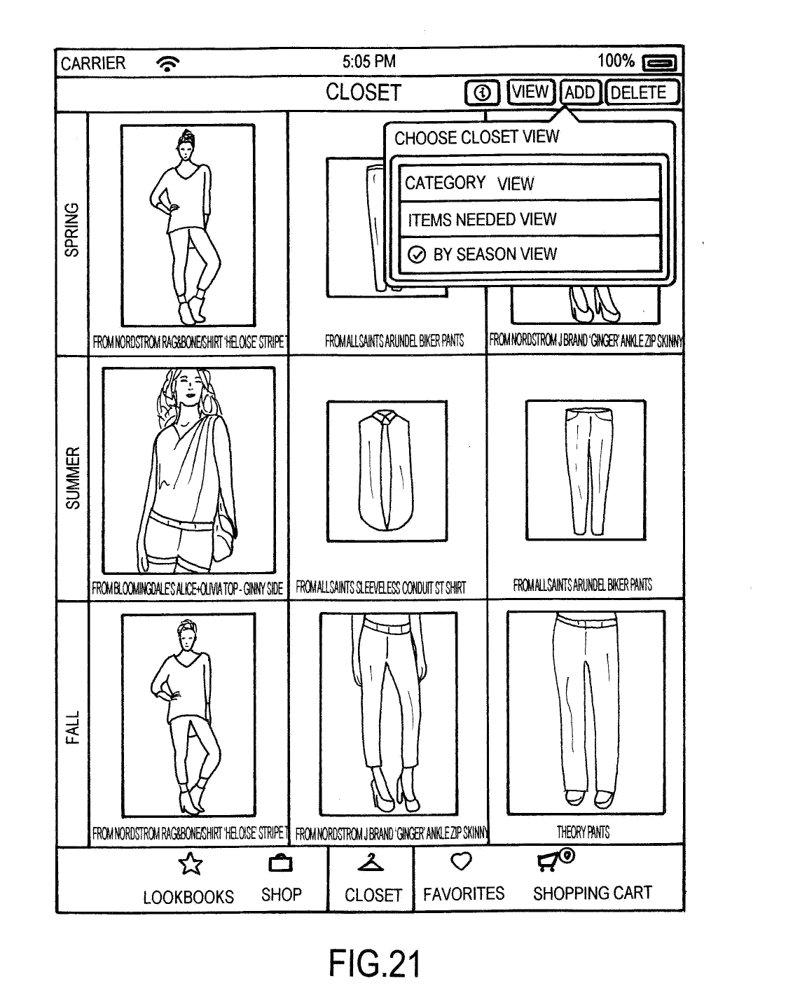

The By Season View is illustrated in FIG. 21. This view rows are labeled with the one of the seasons and each row contains the user's closet items organized by season. This view helps the user visualize their closet by season. To set the Season tags on any closet item, the user taps the closet item image in the Closet view (FIG. 19) to display its Add Details view (FIG. 18). The user then selects one or more of the Seasons tags and saves to return to the Closet view.

As discussed here and elsewhere in this application, the Outfit view may display an n×n matrix of outfit views that have been created by the user in the Shop view, the Closet view and/or the Favorites view. Each outfit view may comprise a composite product (e.g. an ensemble) or any portion of a composite product. The outfit may comprise multiple product images as created and edited by the user. The Outfit view may allow the user to further organize their clothing in a number of ways including, but not limited to: by season, by event (e.g., cocktail party, office function, wedding, date or the like), by day of the week, by wish list (e.g., for outfits created in Shop view, but may not yet have been purchased).

Viewing Favorites

In one embodiment, it may be desirable to allow the user to visualize how the store's merchandise might look with items that the user already owns (e.g., items from their own closet for an apparel application, existing furniture in a room for a home decoration application, etc.). In this embodiment, the user is looking to purchase items from the store to combine with items (clothing for an apparel application, furniture for a home furnishing application, etc.) that they own in order to complete an outfit, room or otherwise an ensemble. When shopping online, the user can either visualize item(s) from memory or look at the actual item while they are paging through the website's content. Either way, it is difficult to do a side-to-side comparison on the store's clothing combine with their closet items.

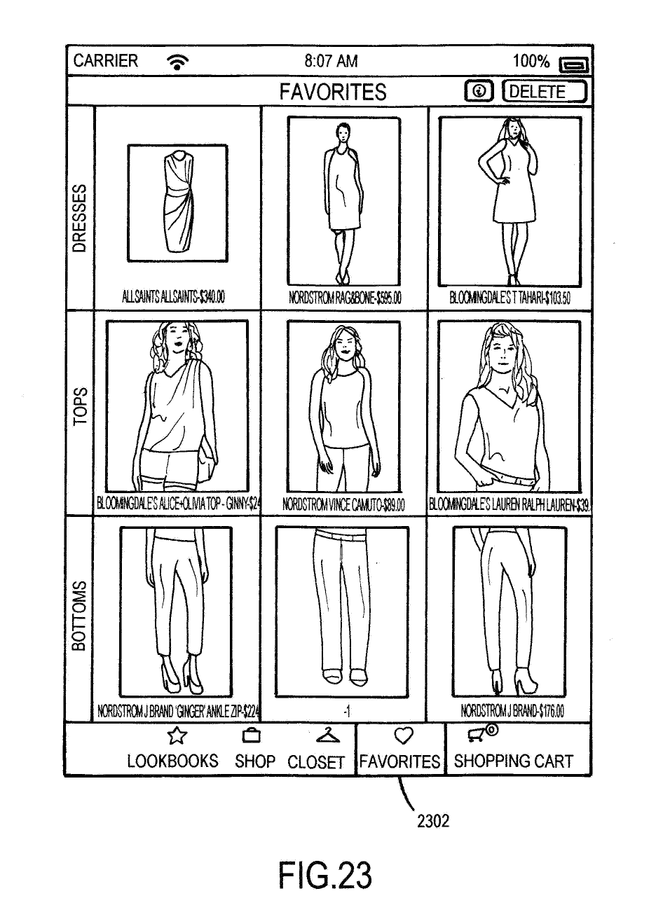

In one embodiment, the user may tap the Favorites tab (2302) located at the bottom of the application to display the Favorites view, as depicted in FIG. 23. In this embodiment, Shop and closet items may be added to the Favorites view by selecting the Favorite button on the Shop Detail Product view (FIG. 12) or the Favorite button on the Closet Add Details view (FIG. 18) respectively.

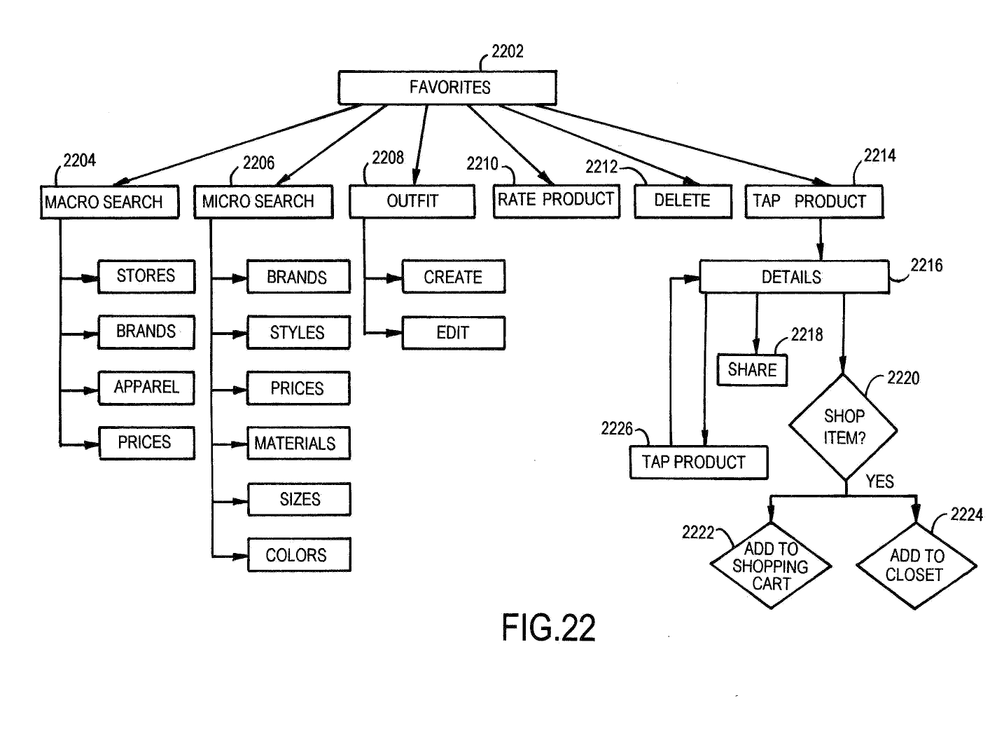

One embodiment of a Favorites Flow Diagram is illustrated in FIG. 22. The user may enter Favorites in any manner known at 2202. A menu may present a number of items and features that allow the user to organize the favorites—such as, Macro Search (2204); Micro Search (2206); Outfit (2208); Rate Product (2210); Delete (2212) or Tap Product (2214). As discussed further herein, the favorite items on the Favorites view can be refined and filtered using the Macro Search and the Micro Search. As also discussed further herein, an Outfit button may be provided to allow the user to create outfits from a combination of their favorite shop items and their favorite closet items. A Delete button may be provided to allow the user to remove items from the favorites as discussed herein.

In one embodiment a Rate Product button (2210) may be provided on shop items to allow the user to tag attributes for the product (including but not limited to tags for life style, body type, etc.), provide a rating the product or an additional rating description for the product. In some embodiments, the user may be rewarded with points that apply towards product discounts or some form of notoriety for rating products. In some embodiments the ratings will be sent to the server where the tags and ratings will be collated by product used to create valuable additional crowd-sourced intelligence on the products.

In continued reference to FIG. 23, FIG. 23 depicts one embodiment of a Favorites view. Favorites view may provide a place for the user to store shop items and closet items. It also serves a number of other functions. It may allow a scratchpad for putting separates together from shop items and closet items and experimenting with creating multiple outfits from a few pieces. It may allow a place for the user to combine their closet items with the shop items in order to visualize how the pieces will go together. Additionally, it may allow a place for the user to store styles as samples of cuts that look good for their body type and coloring. It may allow a place to store wish list items that the user would eventually like to purchase.

Detail Product View

When the user taps a product image on the Favorites view, the Favorites Detail Product view for that product appears. The Favorites Detail Product view is similar to the Shop Detail Product view (FIG. 12) and can present a larger product image, the brand, the product description, the price, the sizes, and the colors.

The buttons on the Favorites Detail Product view vary depending on whether the item was added to Favorites from the Shop Detail Product view (FIG. 12) or the item was added to Favorites from the Closet Add Details view (FIG. 18).

The buttons on the Favorites Detail Product view for favorite Shop items may include a Share button (allowing the user to share the product via email and socially, including but not limited to: Facebook, Pinterest or Twitter), a Cart button (allowing the user to add the item to their Shopping Cart and increment the badge), and a Closet button (allowing the user to add the item to their Closet).

The Favorites Detail Product view for favorite Closet items can include the Share button (allowing the user to share the product via email and socially, including but not limited to: Facebook, Pinterest or Twitter).

The scrolling row of products along the bottom of the Favorites Detail Product view presents additional items to go with the detailed product allowing the user to visually discover more ways to complete an outfit. The product content can be refined and narrowed using the Micro Search button. As the user taps product images on the scrolling row, new Detail Product views are displayed for those products allowing the user to continue to refine outfits.

In one embodiment, it may be desirable that the scrolling row product content for Closet items defaults to the Items Needed tags, if set by the user in the Closet Add Details view (FIG. 18). Such a feature may allow the initial product content to consist of the items needed to complete an outfit from the user's separates.

Viewing Lookbooks

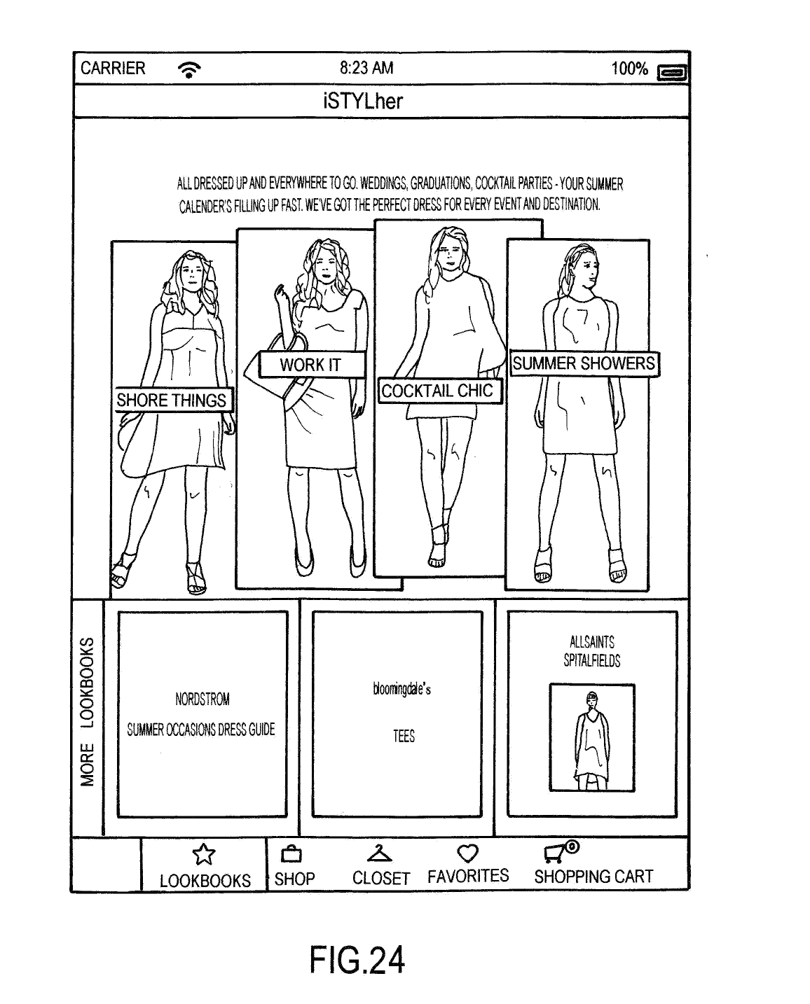

The Lookbooks view is illustrated in FIG. 24 and is a multi-dimensional mini-magazine that shows the latest styles from stores, designers, and bloggers. The Lookbooks view consists of a main image and a scrolling row along the bottom. The scrolling row contains selectable images that represent the mini-magazines, campaigns, and advertisements from stores, designers, and bloggers. When a selectable store, designer, and blogger image is tapped, the main image is replaced with a single or multi-paged mini-magazine or with a video for that store, designer, and blogger. In addition, the scrolling row can animate down and off of the Lookbooks view. In some embodiments, the user can tap on a product image on the main image and the user will be informed that the product information has automatically been added to the their Favorites.

### Other Embodiments

In some embodiments, the application can provide functions to shop for complete outfits or a collection of objects. For example, through the application, the user can simultaneously shop multiple apparel categories from multiple stores and designers allowing the user to shop in terms of outfits instead of separates. In some embodiments, the application can provide functions to filter or narrow down the shopping product content to a specific outfit from a specific store, designer, or brand. For example, the user can use search filters to narrow the product content to view all white blouses with all black leggings with all red high-heels from two stores and five brands. In some embodiments, the application can provide functions to filter or narrow down the shopping product content to certain apparel categories. For example, the user can use search filters to customize which apparel categories they want to view together, i.e., dresses with shoes and accessories, or tops with bottoms and shoes. In some embodiments, the application can provide functions to adapt the product content based on the user's profile. For example, the user can fill out a profile including information about their lifestyle, body type and price range and the product content served to the application for that user will be adapted based on that information. In some embodiments, the application can provide functions to shop to complete outfits from separates in the user's closet. For example, the user can add their clothing to the closet on the application and edit each piece to tag it with one or more items that are needed to complete an outfit. Then later, the user can view each closet item with product content from stores filtered to the items that are needed to complete the outfit.

In some embodiments, the application can provide functions for crowd-sourced popularity rating. For example, a small Like button can be located on a corner of each Shop product. As the user shops for multiple apparel categories from multiple stores and designers, they can quickly tap the Like button for products that appeal to them. All products that are ‘Liked’ in this fashion are sent to the server, where the information is accumulated in the form of a popularity rating for each product.

In some embodiments, the application can provide functions to create a visual closet. For example, the user can add pictures of each clothing item from their closet and tag each item with attributes, including but not limited, to apparel category, season, and items needed to complete an outfit with the clothing piece. In another example, each time the user purchases an item from a store they can be asked if they would like the piece to be automatically added to their closet. In some embodiments, the application can provide functions to organize the user's closet. For example, the user can view their closet items by apparel categories, by season, or by items needed to complete an outfit. In this last case, all of the user's closet items that need a jacket, for instance, are displayed on one row and all of the user's closet items that need a sweater are displayed on another row, and so on. In another example, the user can delete items from their closet as they organize their closet and remove items.

In some embodiments, the application can provide functions to save favorite items. For example, the user can mark shop items to be added to their favorites allowing them to save items that they love or want to consider for future purchases. In another example, the user can mark closet items to be added to their favorites allowing them to mix and view their closet items with items from stores. In some embodiments, the application can provide functions for crowd sourced tagging and rating. For example, the user can be asked if they would like to rate Shop items, added to their Favorites, for points towards discounts. If the user chooses to do so, they can select tags to define additional attributes for the product and/or rate the product.

In some embodiments, the application can provide functions to create and save outfits. For example, in the Shop, the Closet, or the Favorites, the user can enter an outfit mode that allows them to select items to be included in an outfit on its own view. Once the pieces have been selected, they can be arranged, sized, rotated, or edited, and finally, labeled and saved in the Closet.

In some embodiments, the application can provide functions of an aggregated shopping cart. For example, when viewing the details of a shop item, the user can mark the item to be added to a shopping cart and collect multiple items before making a purchase.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A method for providing a shopping portal service for a composite product, said composite product comprising a selection from a set of related product items, further wherein said shopping portal service accessible upon an electronic device, said electronic device comprising a processor, a display, said display capable of being controlled by said processor; the method comprising:
receiving data regarding at least a first set of related product items and a second set of related product items;
partitioning the display into a plurality of separately searchable areas;
displaying a set of said first related product items into a first separately searchable area;
displaying a set of said second related product items into a second separately searchable area; and
searching said set of said first related product items and said set of second related product items wherein a user is capable of viewing a first related product item in proximity with a second related product item upon said display.

2. The method of claim 1 wherein said composite product comprises an outfit and said related product items comprise clothing items.

3. The method of claim 1 wherein said composite product comprises a portion of a house and said related product items comprise home furnishings.

4. The method of claim 1 wherein said set of related product items are from a single merchant.

5. The method of claim 1 wherein said set of related products items are from at least two merchants.

6. The method of claim 1 wherein receiving data regarding at least a first set of related product items and a second set of related product items further comprises:
downloading product data from a merchant web site.

7. The method of claim 1 wherein partitioning said display into a plurality of separately searchable areas further comprises:
partitioning said display into a plurality of stripes, said stripes comprising one of a group, said group comprising: rows and columns.

8. The method of claim 7 wherein each said stripe comprises a set of related product items.

9. The method of claim 8 wherein searching said set of said first related product items and said set of second related product items wherein a user is capable of viewing a first related product item in proximity with a second related product item upon said display further comprises:
scrolling each said set of related product items within its associated stripe.

10. The method of claim 9 wherein scrolling each said set of related product items within its associated stripe further comprises:
scrolling said set of related product item bidirectionally in its associated stripe.

11. The method of claim 9 wherein scrolling each said set of related product item within its associated stripe further comprises:
scrolling said stripes such that at least two stripes display two related product items in proximity according to user command.

12. The method of claim 1 wherein said method further comprises:
sharing the data regarding at least one related product item between a user and another individual.

13. The method of claim 12 wherein sharing the data regarding at least one related product item between a user and another individual further comprises:
sharing the data via one communication channel, said communication channel comprising one of a group, said group comprising: email, socially, via Facebook, via Pinterest and via Twitter.

14. The method of claim 1 wherein said method further comprises:
adding data regarding at least one related product item within a closet of a user.

15. The method of claim 1 wherein said method further comprises:
selecting a first related product item on said display;
selecting a second related product item on said display; and
displaying a composite view of said first related product item and second related product item on said display.

16. The method of claim 1 wherein said step of displaying a composite view of said first related product item and second related product item on said display further comprises:
applying image processing to the image of said first related product item and to the image of said second related product item such that the composite view substantially resembles said a subset of said composite product.

17. A shopping portal system, comprising:
a processor;
a display, said display capable of being controlled by said processor;
a computer readable memory, said computer readable memory capable of storing instructions that when executed by said processor, causes said processor to perform operations comprising:
receiving data regarding at least a first set of related product items and a second set of related product items;
partitioning said display into a plurality of separately searchable areas;
displaying a set of said first related product items into a first separately searchable area;
displaying a set of said second related product items into a second separately searchable area; and
searching said set of said first related product items and said set of second related product items wherein a user is capable of viewing a first related product item in proximity with a second related product item upon said display.

18. The shopping portal system of claim 17 wherein said set of related product items are from a single merchant.

19. The shopping portal system of claim 17 wherein said set of related product items are from at least two merchants.

20. The shopping portal system of claim 17 wherein receiving data regarding at least a first set of related product items and a second set of related product items further comprises:
downloading product data from a merchant web site.

21. The shopping portal system of claim 17 wherein partitioning said display into a plurality of separately searchable areas further comprises:
partitioning said display into a plurality of stripes, said stripes comprising one of a group, said group comprising: rows and columns.

22. The shopping portal system of claim 21 wherein each said stripe comprises a set of related product items.

23. The shopping portal system of claim 22 wherein searching said set of said first related product items and said set of second related product items wherein a user is capable of viewing a first related product item in proximity with a second related product item upon said display further comprises:
scrolling each said set of related product items within its associated stripe.

24. The shopping portal system of claim 23 wherein scrolling each said set of related product items within its associated stripe further comprises:
scrolling said set of related product item bidirectionally in its associated stripe.

25. The shopping portal system of claim 23 wherein scrolling each said set of related product item within its associated stripe further comprises:
scrolling said stripes such that at least two stripes display two related product items in proximity according to user command.

26. The shopping portal system of claim 17 wherein said method further comprises:
sharing the data regarding at least one related product item between a user and another individual.

27. The shopping portal system of claim 26 wherein sharing the data regarding at least one related product item between a user and another individual further comprises:
sharing the data via one communication channel, said communication channel comprising one of a group, said group comprising: email, socially, via Facebook, via Pinterest and via Twitter.

28. The shopping portal system of claim 17 wherein said operations further comprises:
adding data regarding at least one related product item within a closet of a user.

29. The shopping portal system of claim 17 wherein said operations further comprises:
selecting a first related product item on said display;
selecting a second related product item on said display; and
displaying a composite view of said first related product item and second related product item on said display.

30. The shopping portal system of claim 17 wherein displaying a composite view of said first related product item and second related product item on said display further comprises:
applying image processing to the image of said first related product item and to the image of said second related product item such that the composite view substantially resembles said a subset of said composite product.

31. A computer-readable storage media storing instructions that when executed by a computing device, said computing device comprising a processor and a display, said display capable of being controlled by said processor, causes the computing device to perform operations comprising:
receiving data regarding at least a first set of related product items and a second set of related product items;
partitioning said display into a plurality of separately searchable areas;
displaying a set of said first related product items into a first separately searchable area;
displaying a set of said second related product items into a second separately searchable area; and
searching said set of said first related product items and said set of second related product items wherein a user is capable of viewing a first related product item in proximity with a second related product item upon said display.
